(19) United States
(12) Patent Application Publication
(10) Pub. No.: US 2016/0252062 A1
(43) Pub. Date: Sep. 1, 2016

(54) Drive System of a High-Pressure Fuel Pump, High-Pressure Fuel Pump Assembly and Internal Combustion Engine

(71) Applicant: Bayerische Motoren Werke Aktiengesellschaft, Muenchen (DE)

(72) Inventors: Franz KOENIGSMARK, Muenchen (DE); Thomas MITTERAUER, Sierning (AT); Wilfried BARTH, Saxen (AT)

(21) Appl. No.: 15/152,927

(22) Filed: May 12, 2016

Related U.S. Application Data
(63) Continuation of application No. PCT/EP2014/078347, filed on Dec. 18, 2014.

(30) Foreign Application Priority Data
Jan. 31, 2014 (DE) 10 2014 201 789.0

(51) Int. Cl. F02M 59/10; F02M 63/02

(52) U.S. Cl. CPC F02M 59/102; F02M 63/0265

(57) ABSTRACT

A drive system is provided for a high-pressure fuel pump of an internal combustion engine. The drive system includes a drive train which is coupled on the input side to a crankshaft and on the output side to a valve controlling camshaft. At least one drive-system cam which drives the high-pressure fuel pump directly is situated in the drive train at a distance from the valve-controlling camshaft. The drive system has no chain and no toothed belt for driving the drive-system cam. A high-pressure fuel pump assembly and an internal combustion engine having the drive system are also provided.

### CROSS REFERENCE TO RELATED APPLICATIONS

This application is a continuation of PCT International Application No. PCT/EP2014/078347, filed Dec. 18, 2014, which claims priority under 35 U.S.C. §119 from German Patent Application No. 10 2014 201 789.0, filed Jan. 31, 2014, the entire disclosures of which are herein expressly incorporated by reference.

### BACKGROUND AND SUMMARY OF THE INVENTION

The present invention relates to a drive system of a high-pressure fuel pump, to a high-pressure fuel pump assembly and to an internal combustion engine.

High-pressure fuel pumps are already known from the prior art.

High-pressure fuel pumps of this kind are used to pump fuel into the high-pressure reservoir of common rail diesel engines, for example.

Known high-pressure fuel pumps for supplying fuel to an internal combustion engine can be screwed by means of their external housing to the crankcase of the internal combustion engine, for example. They can be driven by way of a chain or a toothed belt, which drives an intermediate shaft. This intermediate shaft is then coupled to a separate shaft, which is situated in the interior of the pump housing and, in turn, has the drive-system cam, which drives a tappet of the high-pressure pump. A high-pressure fuel pump of this kind is also referred to as a “stand-alone” high-pressure fuel pump. It has proven disadvantageous that the necessary robust attachment of such high-pressure fuel pumps to the crankcase leads to relatively high weight, costs and fuel consumption.

The use of a “plug-in pump” to supply fuel to an internal combustion engine is furthermore known. For this purpose, the plug-in pump is screwed to the cylinder head of the internal combustion engine. It is driven by way of a cam, which is seated on the camshaft of the internal combustion engine.

Both the “stand-alone” high-pressure fuel pump and the above-mentioned plug-in pump require a drive system of robust design because high torques occur in the drive system owing to the chain or toothed-belt drive mode. This, in turn, leads to a higher weight of the drive system for such high-pressure fuel pumps and to higher costs. Moreover, fuel consumption is higher because this drive mode for a high-pressure fuel pump is associated with higher frictional losses.

DE 10 2010 016 693 A1 discloses a timing drive for a combustion engine, having a crankshaft chain wheel connected to a crankshaft and an intermediate shaft chain wheel connected to an intermediate shaft for driving a fuel pump. The crankshaft chain wheel and the intermediate shaft chain wheel are connected by a chain, via which a torque is transferred from the crankshaft to the intermediate shaft.

DE 10 2005 023 162 A1 discloses a timing chain drive for an internal combustion engine having a crankshaft chain wheel and an intermediate shaft chain wheel with two toothed rims, wherein one chain is laid around the crankshaft chain wheel and one toothed rim of the intermediate shaft chain wheel in order to drive the intermediate shaft. The intermediate shaft chain wheel drives the drive shaft of a fuel pump. A second chain is laid around the other toothed rim and also around a camshaft wheel in order to drive a valve-controlling camshaft.

It is therefore the object of the present invention to develop a drive system of a high-pressure fuel pump, a high-pressure fuel pump assembly and an internal combustion engine of the type stated at the outset in an advantageous manner, in particular such that the outlay on construction for the drive system in the case of high-pressure fuel pumps can be reduced. The intention is furthermore to optimize the high torques required in the drive system, with the result that it is no longer necessary to make the drive system so massive.

According to the invention, this and other objects are achieved by a drive system of a high-pressure fuel pump of an internal combustion engine having a drive train, which is coupled on the input side to a crankshaft and on the output side to a valve-controlling camshaft, and having at least one drive-system cam, which drives a tappet of the high-pressure fuel pump directly and is situated in the drive train at a distance from the valve-controlling camshaft. An intermediate shaft, on which one drive-system cam is seated, is mounted in the crankcase.

The massive high-pressure pump housing previously required and the dedicated shaft situated in the pump housing are no longer required. On the contrary, an intermediate shaft driven by the crankshaft is provided with a cam which directly drives the tappet. The pump itself thus now only includes the “pump element”, thereby saving considerable installation space. Moreover, the previously required fuel-cooled slide bearings of the shaft in the dedicated pump housing are eliminated.

The drive system preferably has no chain and no toothed belt from the crankshaft to the intermediate shaft. As a result, there is the advantage that chain drives or belt drives of robust design and massive attachment to the crankcase or to the cylinder head are no longer required in a drive system of a high-pressure fuel pump since the high friction power required by a chain or toothed-belt drive is reduced.

The drive system of a high-pressure fuel pump and hence also the high-pressure fuel pump itself can be designed for lower loads, and this allows a significant weight saving.

The drive system can be exclusively mechanical. This results in the advantage that an electric drive is not required for the pump, and the drive system is advantageously less fault-prone.

In particular, the high-pressure fuel pump is a high-pressure fuel pump driven in a purely mechanical way. For example, the high-pressure fuel pump is a high-pressure fuel pump of a unit fuel injector system or common rail system of a diesel engine, in particular a mechanical positive displacement pump. However, the high-pressure fuel pump can also be the fuel pump of a gasoline engine or spark-ignition engine.

The drive-system cam can be designed as a single cam or multiple cam, depending on the number of cylinders. Depending on the number of cylinders, a single cam in the case of two cylinders, a dual cam in the case of four cylinders and a triple cam in the case of six cylinders can be provided, for example. It is thereby possible to reduce weight and to build up the required pressure in the high-pressure reservoir by use of a single high-pressure fuel pump.

Moreover, the drive-system cam CAN be situated between the crankshaft and the camshaft or after the camshaft in the power flow of the drive train. This results in the advantage that the torque required to drive the high-pressure fuel pump can be provided by the drive train between the crankshaft and the camshaft and/or that the camshaft must be designed without an extra drive-system cam. In addition, it is possible to save installation space by such an arrangement. However, it should be emphasized that the intermediate shaft does not necessarily have to be situated in the power flow path between the crankshaft and the camshaft. It would also be possible to design the entire drive train in such a way that the camshaft, on the one hand, and, in parallel therewith, the intermediate shaft are driven by the crankshaft without the torque being passed from the intermediate shaft to the camshaft in succession.

The drive system can furthermore have at least one intermediate shaft, on which the drive-system cam is seated.

The intermediate shaft is preferably not integrated into the high-pressure fuel pump. It can be positioned separately and arbitrarily as a distinct component, e.g. accommodated and supported in the crankcase of the internal combustion engine.

By way of the intermediate shaft, further units can be driven, e.g. a water pump, an oil pump, a vacuum pump and/or a generator. It is thereby advantageously possible to use the torque transferred to the intermediate shaft to drive further units. One or more of these units can be driven. These units can either be flanged on directly or, for example, driven via gearwheel stages, belts, toothed belts or a chain.

The intermediate shaft can be drivable by way of an intermediate gear mechanism. This results in the advantage that the high driving torques for the high-pressure fuel pump are transferred with little friction by gearwheels, thereby replacing the robust chain and belt drives for driving the pump.

The intermediate gear mechanism can transfer torque directly from the crankshaft to the intermediate shaft.

However, it is also contemplated for the intermediate gear mechanism to transfer the torque required for driving from the valve-controlling camshaft to the intermediate shaft.

As an alternative, the intermediate shaft can drive the valve-controlling camshaft or, if the internal combustion engine has two camshafts, can drive both camshafts. This can be accomplished by use of a toothed belt or a chain, for example.

Moreover, the intermediate gear mechanism can have at least one gearwheel seated on the crankshaft and at least one gearwheel seated on the intermediate shaft. Direct torque transfer from the shaft to the gearwheels without significant frictional loss is thereby made possible. In addition, this results in the advantage that torque transfer is made possible in a robust manner and, at the same time, by use of less heavy parts. Massive attachment of the high-pressure fuel pump to the crankcase or to the cylinder head can also be eliminated because both the crankshaft and the intermediate shaft are mounted in a sufficiently robust manner and can therefore absorb corresponding torques and forces.

The gearwheels on the crankshaft and intermediate shaft can preferably intermesh. A simple construction and direct transfer of high torques with low frictional loss are thereby made possible.

As an alternative, the object is achieved by a drive system of a high-pressure fuel pump of an internal combustion engine, said drive system having a drive train, which is coupled on the input side to a crankshaft and on the output side to a valve-controlling camshaft, and having at least one drive-system cam, which drives a tappet of the high-pressure fuel pump directly and is situated in the drive train at a distance from the valve-controlling camshaft, wherein the drive-system cam is seated on the crankshaft.

If the drive-system cam is seated on the crankshaft, there is the advantage that there is no longer the need for a mechanism to transfer the driving torque for the high-pressure fuel pump. On the contrary, the drive-system cam seated on the crankshaft drives the high-pressure fuel pump directly, which is once again embodied without a dedicated housing with an integrated intermediate shaft, thereby saving weight and installation space.

In particular, the drive-system cam can be mounted on the front or rear end of the crankshaft. The drive-system cam can be fitted there. However, it can also be machined into the crankshaft.

According to another embodiment, the drive-system cam can be seated on one web of the crankshaft, being machined in or fitted.

Moreover, the present invention relates to a high-pressure fuel pump assembly. A high-pressure fuel pump assembly of this kind has at least one high-pressure fuel pump and at least one drive system according to the invention.

Moreover, the high-pressure fuel pump can be embodied as a plug-in pump.

Moreover, the present invention relates to an internal combustion engine. An internal combustion engine of this kind has at least one drive system according to the invention or at least one high-pressure fuel pump assembly according to the invention.

The internal combustion engine is preferably a diesel engine.

However, it is also contemplated for the internal combustion engine to be embodied as a gasoline engine or spark-ignition engine. In particular, it is possible in an embodiment of this kind for the drive-system cam for driving the high-pressure fuel pump to be mounted on a balancer shaft.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of an illustrative embodiment of a drive system according to the invention for a high-pressure fuel pump installed in a high-pressure fuel pump assembly according to the invention for an internal combustion engine according to the invention:

FIG. 2 is a view of the end of the drive system shown in FIG. 1;

FIG. 3 is a top plan view of the drive system shown in FIGS. 1 and 2;

FIG. 4 is another view of the end of the drive system shown in FIG. 1 with the drive for additional units:

FIG. 5 is a perspective view of another illustrative embodiment of a drive system according to the invention for a high-pressure fuel pump installed in a high-pressure fuel pump assembly according to the invention for an internal combustion engine according to the invention:

FIG. 6 is a view of the end of the drive system shown in FIG. 5;

FIG. 7 is a top plan view of the drive system shown in FIGS. 5 and 6:

FIG. 8 is a perspective view of another illustrative embodiment of a crankshaft for a drive system according to the invention for a high-pressure fuel pump installed in a high-pressure fuel pump assembly according to the invention for an internal combustion engine according to the invention:

FIG. 9 is a view of the end of the drive system shown in FIG. 8;

FIG. 10 is a top plan view of the drive system shown in FIGS. 8 and 9; and

FIG. 11 is a perspective view of another illustrative embodiment of a drive system according to the invention for a high-pressure fuel pump installed in a high-pressure fuel pump assembly according to the invention for an internal combustion engine according to the invention.

### DETAILED DESCRIPTION OF THE DRAWINGS

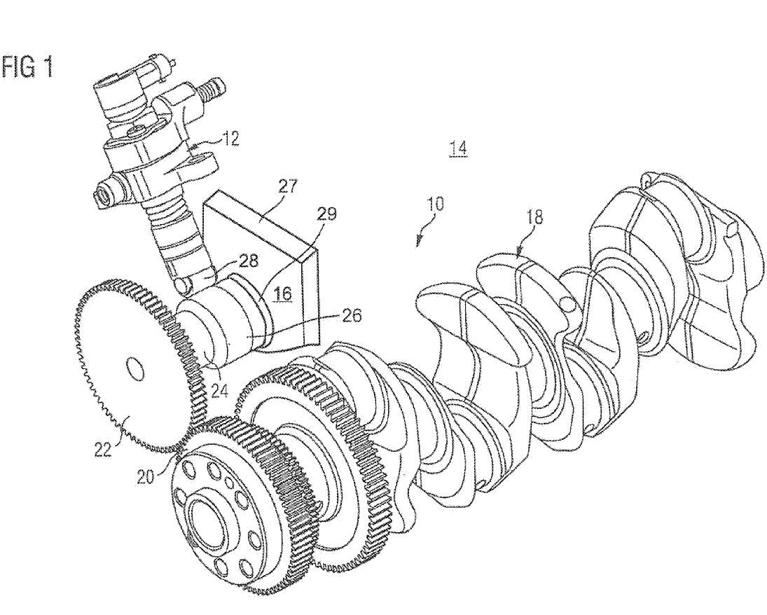

FIG. 1 shows a first illustrative embodiment of a drive system 10 for a high-pressure fuel pump 12 installed in a high-pressure fuel pump assembly 16 according to the invention for an internal combustion engine 14.

The high-pressure fuel pump assembly 16 shown in FIG. 1 is installed in an internal combustion engine 14 according to the invention.

The drive system 10 has an illustrated drive train, which is coupled on the input side to a crankshaft 18 and on the output side to a valve-controlling camshaft (not shown specifically here).

In the embodiment shown in FIG. 1, the internal combustion engine 14 is a diesel engine with common rail technology, and the high-pressure fuel pump 12 is arranged on the inlet side ahead of the “rail” or high-pressure reservoir.

The crankshaft 18 of the internal combustion engine 14 is provided at the end with a crankshaft gearwheel 20. Here, this crankshaft gearwheel 20 is secured on an extension of the crankshaft 18 by way of a conventional shaft-hub joint.

The crankshaft gearwheel 20 meshes with an intermediate shaft gearwheel 22 and forms an intermediate gear mechanism of the drive system 10, wherein the gearwheels can be biased or unbiased.

The intermediate shaft gearwheel 22 is seated on the end of an intermediate shaft 24 and is likewise secured there by way of a conventional shaft-hub joint.

At its end remote from the intermediate shaft gearwheel 22, the intermediate shaft 24 carries a drive-system cam 26, which is here embodied as a dual cam in accordance with the number of cylinders of the internal combustion engine 14.

In this case, the intermediate shaft 24 is mounted directly in the crankcase 27 of the internal combustion engine 14 by means of a rolling or a slide bearing 29.

The drive-system cam 26 is thus situated at a distance from the valve-controlling camshaft in the drive train of the internal combustion engine 14. Moreover, the drive system 10 does not have a chain or a toothed belt for driving the drive-system cam 26, the latter being driven purely mechanically however.

The drive-system cam 26 is situated between the driving crankshaft 18 and the driven valve-controlling camshaft in the power flow of the drive train.

The drive-system cam 26 is furthermore placed against a tappet 28 of the high-pressure fuel pump 12, with the result that it directly drives the high-pressure fuel pump 12.

Here, the high-pressure fuel pump 12 is embodied as a plug-in pump.

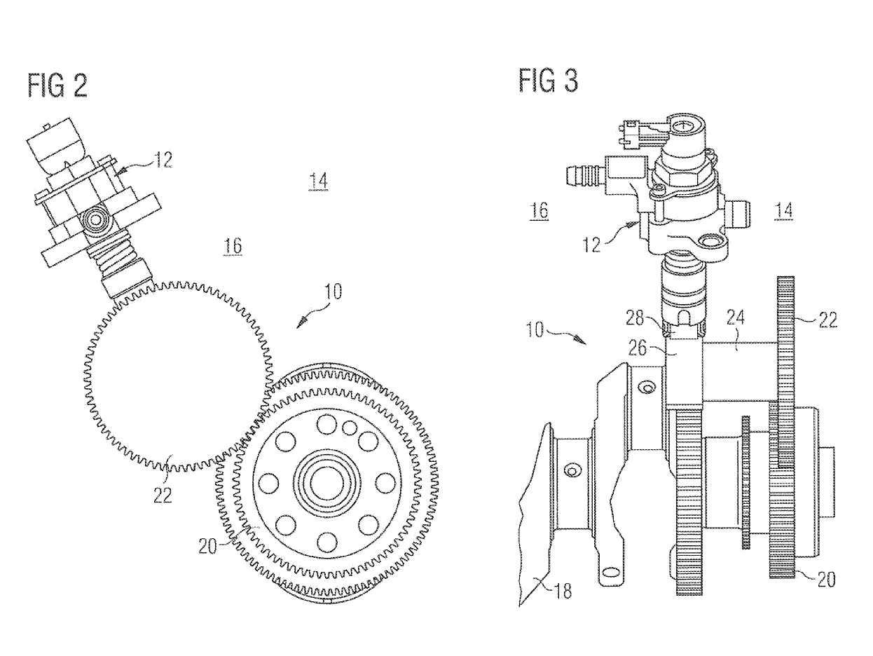

FIG. 2 shows a view of the end of the drive system shown in FIG. 1 and FIG. 3 shows a plan view of the drive system shown in FIGS. 1 and 2.

The operation of the illustrative embodiment shown in FIGS. 1 to 3 is as follows.

The crankshaft 18 converts the motion of the pistons of the internal combustion engine 14 into a rotary motion. The torque thereby applied to the crankshaft 18 is transferred to the intermediate shaft gearwheel 22 by way of the crankshaft gearwheel 20. The intermediate shaft gearwheel 22, in turn, drives the drive-system cam 26, which mechanically actuates the high-pressure fuel pump 12, which operates as a mechanical positive displacement pump.

In the high-pressure fuel reservoir or rail (not shown specifically), the high-pressure fuel pump 12 builds up pressure by pumping in fuel.

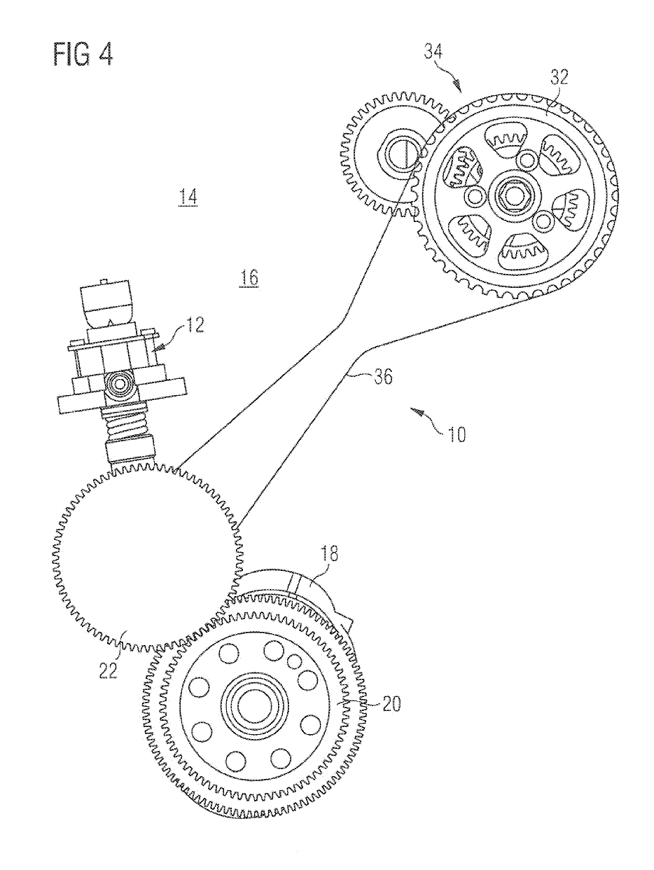

FIG. 4 shows the drive system 10 shown in FIGS. 1 to 3 with one addition, wherein the crankcase 27 and the bearing 29 of the intermediate shaft 24 have been omitted purely for graphical reasons.

Further units 32, which are represented symbolically here and of which only one gearwheel input stage 34 can be seen, such as a water pump, an oil pump, a vacuum pump and/or a generator, are here assigned to the drive system 10. As an alternative or in addition, the valve-controlling camshaft can also be driven by the gearwheel input stage 34.

In terms of drive, the units 32 are connected to the intermediate shaft 24 by way of a toothed belt 36 or a chain. As an alternative, the units 32 can also be driven directly by the intermediate shaft 24. It is, of course, furthermore possible to drive the camshaft or the shaft with the auxiliary units by means of a further gearwheel stage arranged after the intermediate shaft 24, on the output side.

However, the units and/or the valve-controlling camshaft do not have to be driven by the intermediate shaft 24; they can also be driven separately by the crankshaft.

The embodiment of the drive system 10 shown in FIG. 4, which is based on the drive system shown in FIGS. 1 to 3, has the following additional function.

Here, the further units 32, e.g. a water pump, an oil pump, a vacuum pump or a generator, and/or the camshaft, are driven by way of the intermediate shaft 24. The torque transferred to the intermediate shaft 24 is thus advantageously used to drive further units. One or more of these units can be driven. Here, these units are driven by way of the toothed belt 36 or a chain.

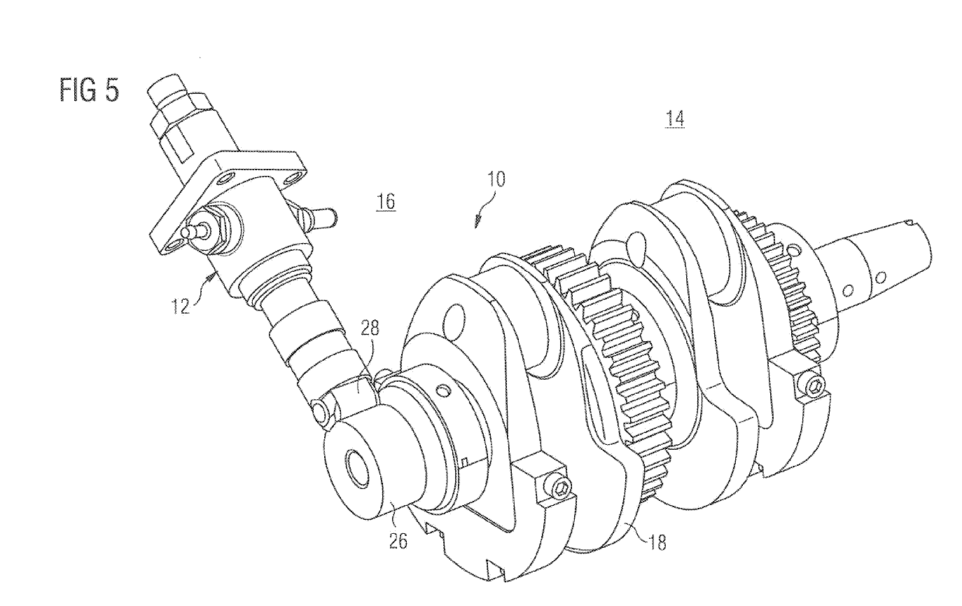

FIG. 5 shows a modification of the drive system 10 shown in FIGS. 1 to 3.

The drive system 10 shown in FIG. 5 is substantially identical in terms of structure and operation to the drive system 10 shown in FIGS. 1 to 3 and described above. However, it differs in that the drive-system cam 26 is seated directly on the crankshaft 18. Here, the drive-system cam 26 is machined directly into the end of the crankshaft 18.

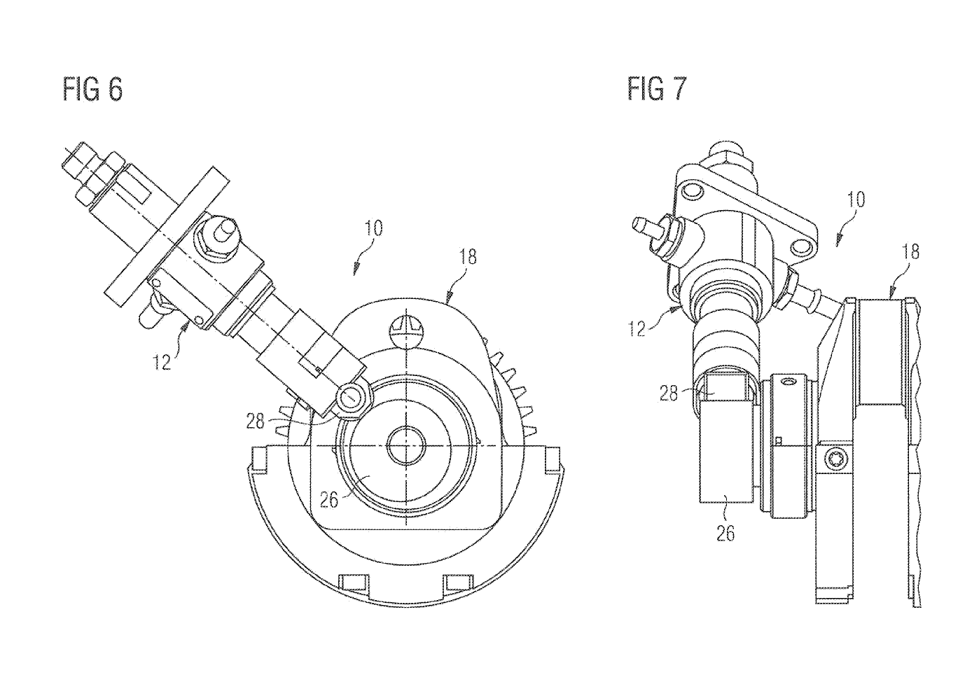

FIG. 6 shows a view of the end of the drive system shown in FIG. 5 and FIG. 7 shows a plan view of the drive system shown in FIGS. 5 and 6.

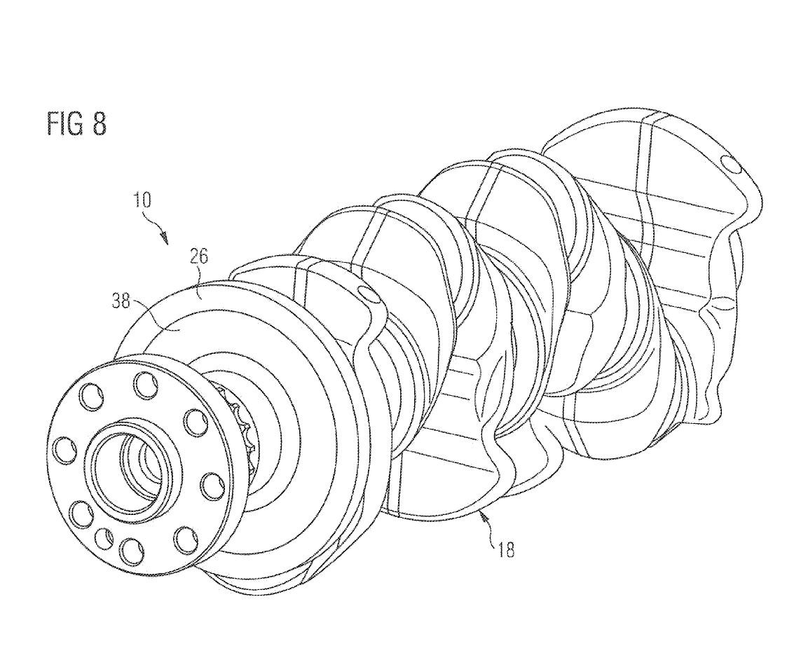

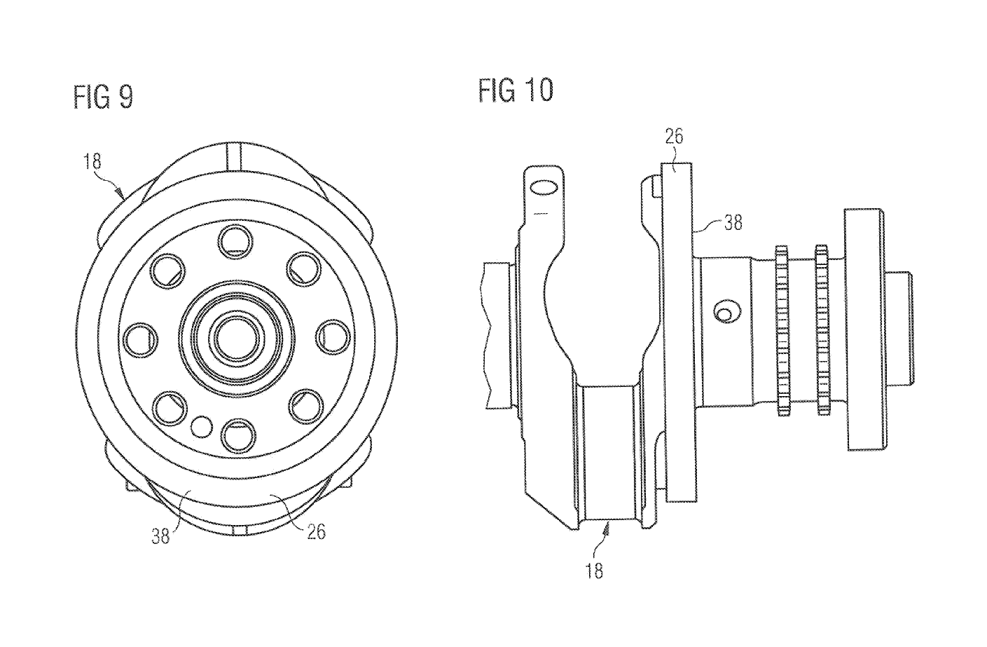

FIGS. 8 to 10 show a modification of the illustrative embodiment of a drive system 10 shown in FIG. 5.

As shown in FIGS. 8 to 10, the drive-system cam 26 can also be machined into one web 38 of the crankshaft 18. In other respects, the illustrative embodiment shown in FIG. 8 is identical in structure and operation to the illustrative embodiment shown in FIG. 5. The ring gears shown at the right-hand end of the crankshaft 18 in FIG. 10 are used to drive units and/or the valve-controlling camshaft.

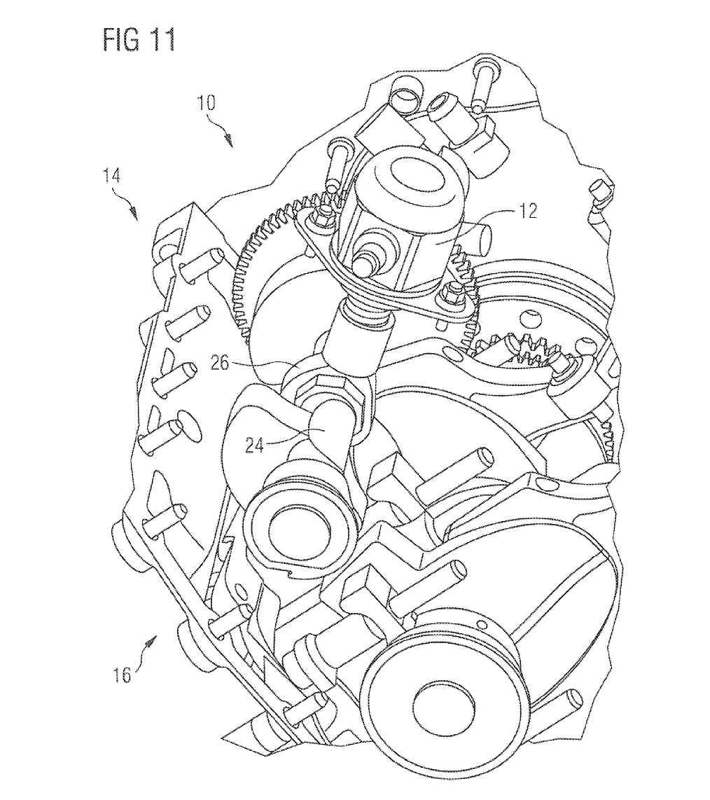

FIG. 11 shows another embodiment of a drive system 10 according to the invention for an internal combustion engine 14, although this is a spark-ignition engine. Here, the intermediate shaft 24 is a balancer shaft which carries the drive-system cam 26. Here, the high-pressure fuel pump 12 is used to pump gasoline or fuel for spark ignition.

In other respects, the illustrative embodiment shown in FIG. 11 is substantially identical in structure and operation to the illustrative embodiment shown in FIG. 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drive system of a high-pressure fuel pump of an internal combustion engine, comprising:
a drive train coupled on an input side to a crankshaft and on an output side to a valve-controlling camshaft;
a drive-system cam configured to drive directly a tappet of the high-pressure fuel pump;
an intermediate shaft on which the drive-system cam is seated, wherein
the drive-system cam is situated in the drive train at a distance from the valve-controlling camshaft, and
the intermediate shaft is mounted in a crankcase of the internal combustion engine.

2. The drive system according to claim 1, wherein the drive-system cam is configured as a single cam or a multiple cam depending on a number of cylinders of the internal combustion engine.

3. The drive system according to claim 1, wherein the drive-system cam is located between the crankshaft and the camshaft or is located after the camshaft in a power flow of the drive train.

4. The drive system according to claim 1, wherein there is no chain or toothed belt in the drive system for driving the drive-system cam.

5. The drive system according to claim 1, further comprising an intermediate gear mechanism by which the intermediate shaft is driven.

6. The drive system according to claim 5, wherein the intermediate gear mechanism comprises a gearwheel seated on the crankshaft and a gearwheel seated on the intermediate shaft, the crankshaft gearwheel and the intermediate shaft gearwheel intermeshing with one another.

7. A drive system of a high-pressure fuel pump of an internal combustion engine, comprising:
a drive train coupled on an input side to a crankshaft and on an output side to a valve-controlling camshaft;
a drive-system cam configured to drive directly a tappet of the high-pressure fuel pump, wherein
the drive-system cam is situated in the drive train at a distance from the valve-controlling camshaft, and
the drive-system cam is seated on the crankshaft.

8. The drive system according to claim 7, wherein the drive-system cam is seated on one end of the crankshaft or is seated on one web of the crankshaft.

9. A high-pressure fuel pump assembly, comprising:
a high-pressure fuel pump of an internal combustion engine; and
a drive system according to claim 1.

10. The high-pressure fuel pump assembly according to claim 9, wherein the high-pressure fuel pump is a plug-in pump.

11. A high-pressure fuel pump assembly, comprising:
a high-pressure fuel pump of an internal combustion engine;
a drive system according to claim 7.

12. The high-pressure fuel pump assembly according to claim 11, wherein the high-pressure fuel pump is a plug-in pump.

13. An internal combustion engine comprising a high-pressure fuel pump assembly according to claim 9.

14. An internal combustion engine comprising a high-pressure fuel pump assembly according to claim 11.
